(19) United States
(12) Patent Application Publication
(10) Pub. No.: US 2008/0192030 A1
(43) Pub. Date: Aug. 14, 2008

(54) Serial Data Transmission Method and Related Apparatus for Display Device

(76) Inventors: Chia-Jung Yang, Taipei City (TW); Che-Li Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/776,551

(22) Filed: Jul. 11, 2007

(30) Foreign Application Priority Data
Feb. 13, 2007 (TW) 096105309

(51) Int. Cl. G06F 3/038

(52) U.S. Cl. 345/204

(57) ABSTRACT

In order to mitigate signal reflections in a transmission interface of a display device, the present invention provides a serial transmission method for embedding data and non-data signals into transmission lines for a display device. The serial transmission method includes: obtaining a plurality of data transmission modes of the display device; defining a plurality of current patterns by a plurality of current intensities and a plurality of current directions according to the plurality of data transmission modes, each current pattern corresponding to one of the plurality of data transmission modes; and outputting one of the plurality of current patterns to an electronic device of the display device via a plurality of transmission lines according to a present data transmission mode.

### BACKGROUND OF THE INVENTION

1. Field of the Invention

The present invention relates to a serial transmission method and related apparatus, and more particularly, to a serial transmission method utilized for embedding data and non-data signals into transmission lines for a display device and related apparatus that can mitigate signal reflections.

2. Description of the Prior Art

A liquid crystal display (LCD) device is a flat panel display (FPD) characterized by thin appearance, low radiation and low power consumption. The LCD device has gradually replaced a traditional cathode ray tube (CRT) display, and is widely applied in various electronic products such as a notebook computer, a personal digital assistant (PDA), a flat panel television, and a mobile phone. Common FPD devices include thin-film transistor liquid crystal display (TFT-LCD) devices, low temperature poly silicon liquid crystal display (LTPS-LCD) devices, and organic light emitting diode (OLED) display devices. A driving system of a display device includes a timing controller, a plurality of source drivers, and a plurality of gate drivers. Interfaces between the timing controller and the plurality of source drivers generally use a bus-type architecture to transmit various signals, such as clock, data, control, and setting signals. Typical interfaces used in an LCD device include transistor-transistor logic (TTL) interfaces, reduced swing differential signal (RSDS) interfaces, and mini low voltage differential signal (mini-LVDS) interfaces, etc.

Please refer to FIGS. 1 and 2, which are schematic diagrams of a signal of the reduced swing differential signal (RSDS) interface for use in a display device according to the prior art. In FIG. 1, a timing controller of the display device generates a pair of differential voltage signals DxN and DxP having the same slew rate and phase difference of 180 degrees. Amplitudes of the differential voltage signals DxN and DxP swing according to a common voltage reference level. In FIG. 2, subtraction of the differential voltage signal DxN from DxP(DxP−DxN) gives a differential voltage signal DIF having a positive voltage swing VIH and a negative voltage swing VIL with amplitude equaling the difference of the wave peak of the differential voltage signal DxP and the wave valley of the differential voltage signal DxN.

Please refer to FIGS. 3 and 4, which are current patterns of high and low signal states of RSDS line pairs D00P/N, D01P/N, D02P/N, D03P/N, D10P/N, D11P/N, D12P/N, D13P/N, D20P/N, D21P/N, D22P/N and D23P/N. In FIGS. 3 and 4, a transmitting terminal Tx represents the timing controller, whereas a receiving terminal Rx represents a source driver. The transmitting terminal Tx generates differential currents for each of the RSDS line pairs, and the receiving terminal Rx determines signal states by decoding the current directions. For example, as shown in FIG. 3, the current flow from the RSDS line D01P to D01N can be decoded to be the high signal state, as well as bit information of ‘1’. In FIG. 4, the current flow from the RSDS line D01N to D01P can be decoded to be the low signal state, as well as bit information of ‘0’. Therefore, each RSDS line pair can only be used to represent one-bit information.

Please refer to FIG. 5, which is a timing diagram of RSDS signals in the display device according to FIGS. 3 and 4. From top to bottom, the RSDS signals are a clock signal S_{CLK}, a left/right shift signal S_{SHL}, a polarity signal S_{POL}, the RSDS signals of the RSDS line pairs D00P/N, D01P/N, D02P/N, D03P/N, D10P/N, D11P/N, D12P/N, D13P/N, D20P/N, D21P/N, D22P/N and D23P/N, a latch signal S_{DIO}, an output sync signal S_{LD}, and a voltage output signal S_{OUTPUT}. The source driver performs configuration changes with control and setting signals including the left/right shift signal S_{SHL}, the polarity signal S_{POL}, the latch signal S_{DIO}, and the output sync signal S_{LD}, and receives data signals via the RSDS line pairs. The detailed operating principle thereof is described as follows. When a falling edge of the clock signal S_{CLK} latches the high state of the latch signal S_{DIO} (point A), the RSDS signals start to transmit image data through dual edge sampling (points B and C) in two falling edges of the clock signal S_{CLK} (point B). The source driver synchronizes output time of the image data with the output sync signal S_{LD} (point D) and thereby transfers the image data for a panel of the display device. The timing controller of the prior art utilizes the TTL interface to transmit the control and setting signals and the RSDS interface to transfer the data signals for the source drive.

In the display device of the prior art, the data signals and the control, setting, and clock signals are transmitted via two different interfaces, which may cause signal skewing. Some parameters, such as setup time or hold time, are not easily adjusted for cooperation with each other. Thus, the display device of the prior art is incapable of operating at high data or clock rates for high-rate, high-resolution applications. In addition, the RSDS interface is only used for transmitting data and clock signals, and the signal states thereof are only determined by the current directions. The transmission lines used in the RSDS and TTL interfaces may require of a large number of wires as higher color-depth demand is applied to each pixel. Furthermore, using individual RSDS line pairs to transmit the data signals increases numbers of lines and layers, occupying large space in a printed circuit board (PCB). On the other hand, the source driver usually uses different pins, such as a right/left shift pin, a data reverse pin, a low-power control pin, and a charge sharing pin, to receive corresponding signals. In such architecture, the pin pitch becomes too fine due to the large number of pins. Thus, the yield of a bonding process for the source driver may decrease.

### SUMMARY OF THE INVENTION

It is therefore an objective of the present invention to provide a serial transmission method for embedding data and non-data signals into transmission lines for a display device and related apparatus.

The present invention discloses a serial transmission method for a display device. The serial transmission method includes the following steps. A plurality of data transmission modes of the display device is obtained. A plurality of current patterns is defined by a plurality of current intensities and a plurality of current directions according to the plurality of data transmission modes, where each current pattern corresponds to one of the plurality of data transmission modes. One of the current patterns is then outputted to an electronic device of the display device via a plurality of transmission lines according to a present data transmission mode.

The present invention further discloses a serial interface device for a display device. The serial interface device includes a plurality of transmission lines, a storage unit, a decision unit and a current output unit. The storage unit is used for storing a plurality of current patterns defined by a plurality of current intensities and a plurality of current directions, where each current pattern corresponds to one of a plurality of data transmission modes of the display device. The decision unit is coupled to the storage unit and used for selecting a current pattern from the plurality of current patterns stored in the storage unit according to a present data transmission mode. The current output unit is coupled to the decision unit and used for outputting the current pattern to an electronic device of the display device via the plurality of transmission lines.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1 and 2 are schematic diagrams of a signal of a reduced swing differential signal (RSDS) interface in a display device according to the prior art.

FIGS. 3 and 4 are current patterns of high and low signal states of the RSDS interface according to a display device of the prior art.

FIG. 5 is a timing diagram of the RSDS interface signals according to the prior art.

FIG. 6 is a flowchart of a process according to the present invention.

FIGS. 7-9 are schematic diagrams of signals of the differential signal interface according to an embodiment of the present invention.

FIGS. 10-17 are current patterns and corresponding data transmission modes according to an embodiment of the present invention.

FIG. 18 is a timing diagram of a serial interface according to FIGS. 10-17.

FIG. 19 is a timing diagram of a serial interface according to an embodiment of the present invention.

FIG. 20 is a schematic diagram of a serial interface device for a timing controller of a display device according to an embodiment of the present invention.

### DETAILED DESCRIPTION

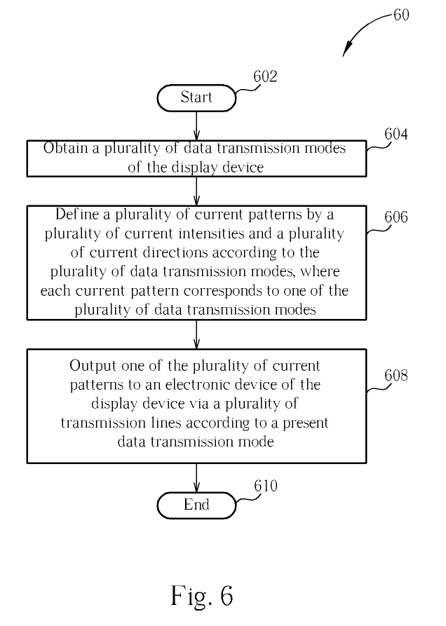

Please refer to FIG. 6, which is a flowchart of a process 60 for performing serial transmission according to the present invention. The process 60 includes the following steps:

Step 602: Start.

Step 604: Obtain a plurality of data transmission modes of the display device.

Step 606: Define a plurality of current patterns by a plurality of current intensities and a plurality of current directions according to the plurality of data transmission modes, where each current pattern corresponds to one of the plurality of data transmission modes.

Step 608: Output one of the plurality of current patterns to an electronic device of the display device via a plurality of transmission lines according to a present data transmission mode.

Step 610: End.

According to the process 60, to transmit data and non-data signals (e.g. control and setting signals) to the electronic device, the present invention defines a current pattern for each data transmission mode of the display device according to the number and types of the data transmission modes. The current patterns are defined by various current directions and intensities.

The present invention can be applied in a transmission interface between any two devices of the display device. For clear explanation of the present invention, transmission manners between a timing controller and a source driver are considered in the embodiments of the present invention hereinafter. And, differential signaling lines are regarded as the transmission lines. Thus, the timing controller transmits signals corresponding to different data transmission modes to the source driver by outputting different current patterns. For example, a first mode is used for transmitting reset and synchronization signals, whereas a second mode is used for transmitting a data signal. In this situation, as a certain signal is transmitted to the source driver, the process 60 generates a current pattern corresponding to a transmission mode used for transmitting the signal, and outputs the current pattern via the transmission lines (e.g. the differential signaling line pair) to the source driver.

Please note that the current intensities and directions provided in the transmission lines can be modified according to the requirements of the display device. The current patterns are accordingly changed as well. For example, two current intensities and one current direction can be adopted to define the current patterns. Or, three current intensities and two directions can be a choice as well. For example, assume that 11 and 12 represent two current intensities, whereas I+ and I− represent ‘positive’ and ‘negative’ current directions, respectively. Moreover, a differential signaling line pair DATAxP/DATAxN is used to output current patterns. Thus, four current patterns can be defined as: (1) DATAxP: I₁+, DATAxN: I₁−, (2) DATAxP: I₁−, DATAxN: I₁+, (3) DATAxP: I₂+, DATAxN: I₂−, and (4) DATAxP: I₂−, DATAxN: I₂+. The current patterns [(1), (2) and [(3), (4) correspond to two data transmission modes for transmitting different signals. (1) and (2) represent the high and low states of one signal, whereas (3) and (4) represent the high and low states of the other signal. Take another example for further explanation. If the current intensities I₁ and I₂, and the current directions I+ and I−, are provided in differential signaling line pairs DATA0P/DATA0N and DATA1P/DATA1N, sixteen different current patterns are possible, as follows:

(1) DATA0P: I₁+, DATA0N: I₁−, DATA1P: I₂+, DATA1N: I₂−;

(2) DATA0P: I₁+, DATA0N: I₁−, DATA1P: I₂−, DATA1N: I₂+;

(3) DATA0P: I₁−, DATA0N: I₁+, DATA1P: I₂+, DATA1N: I₂−;

(4) DATA0P: I₁−, DATA0N: I₁+, DATA1P: I₂−, DATA1N: I₂+;

(5) DATA0P: I₂+, DATA0N: I₂−, DATA1P: I₁+, DATA1N: I₁−;

(6) DATA0P: I₂+, DATA0N: I₂−, DATA1P: I₁−, DATA1N: I₁+;

(7) DATA0P: I₂−, DATA0N: I₂+, DATA1P: I₁+, DATA1N: I₁−;

(8) DATA0P: I₂−, DATA0N: I₂+, DATA1P: I₁−, DATA1N: I₁+;

(9) DATA0P: I₁+, DATA1N: I₁−, DATA1P: I₂+, DATA0N: I₂−;

(10) DATA0P: I₁+, DATA1N: I₁−, DATA1P: I₂−, DATA0N: I₂+;

(11) DATA0P: I₁−, DATA1N: I₁+, DATA1P: I₂+, DATA0N: I₂−;

(12) DATA0P: I₁−, DATA1N: I₁+, DATA1P: I₂−, DATA0N: I₂+;

(13) DATA0P: I₂+, DATA1N: I₂−, DATA1P: I₁+, DATA0N: I₁−;

(14) DATA0P: I₂+, DATA1N: I₂−, DATA1P: I₁−, DATA0N: I₁+;

(15) DATA0P: I₂−, DATA1N: I₂+, DATA1P: I₁+, DATA0N: I₁−;

(16) DATA0P: I₂−, DATA1N: I₂+, DATA1P: I₁−, DATA0N: I₁+;

As can be understood from the above, the current intensities are not limited to certain levels in the present invention, and those skilled in the art could make modications if neccesary.

From the above, the RSDS interface of the prior art merely utilizes the current directions to define signal states, such as the positive direction representing the high signal state. Furthermore, the RSDS interface is used to trasmit image data only, resulting in a need for a large amount of transmission lines in the prior art display device when applied to high data-load applications. On the contrary, the process 60 utilizes both the current intensities and directions to define multiple current patterns, and thereby trasmits singals to the source driver according to the data transmission modes corresponding to the current patterns. The present invention embeds various types of signals (e.g. data or control signals) into the same serial interface, reducing the wiring number and area on the PCB greatly.

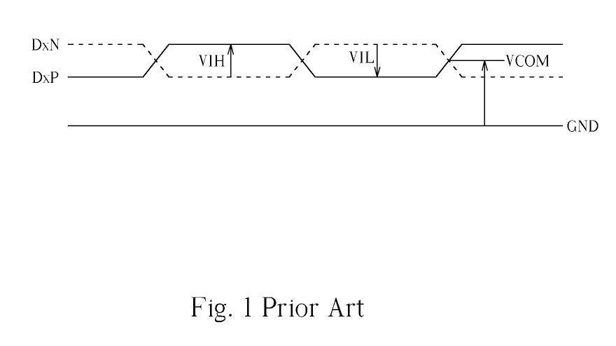

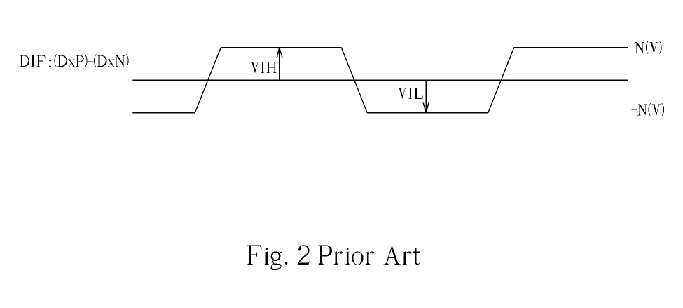

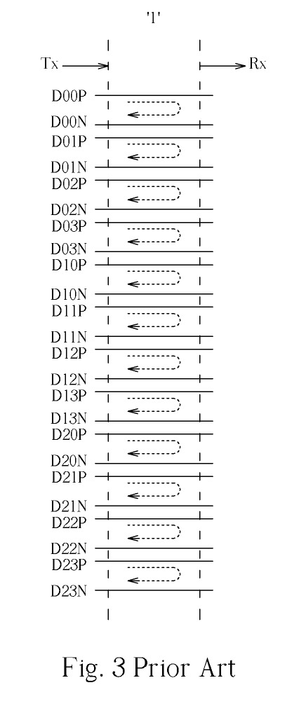

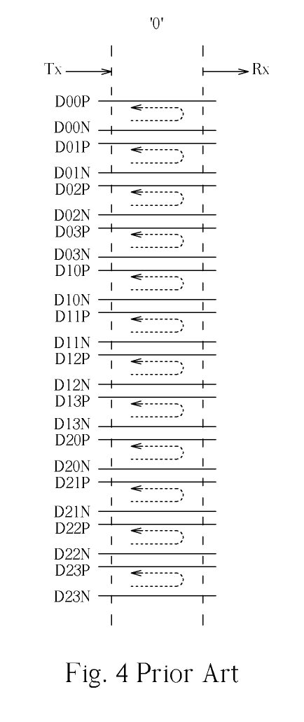

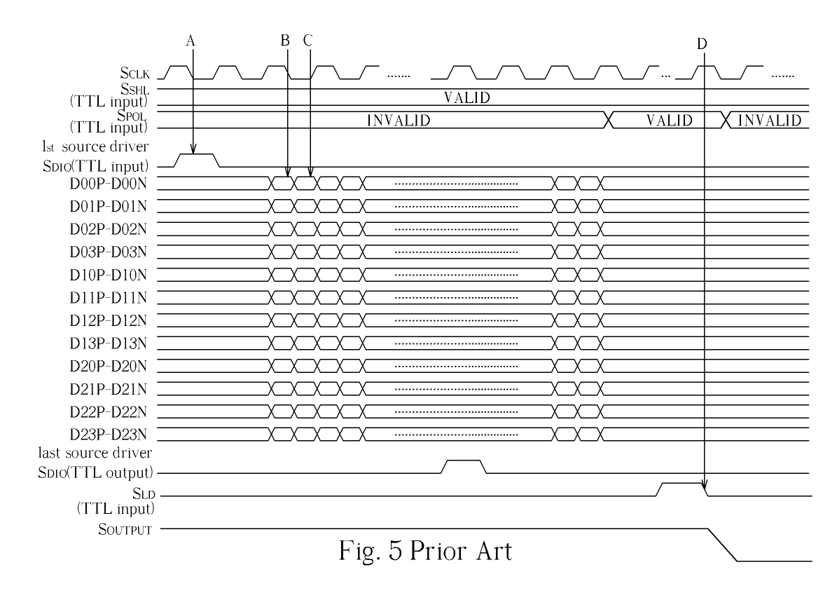

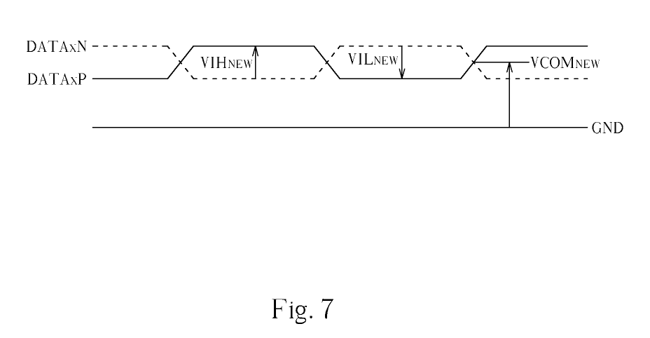

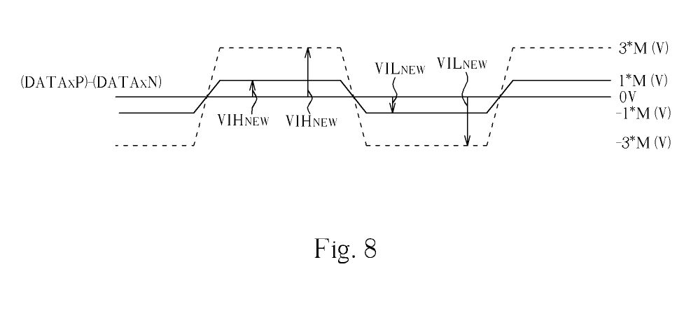

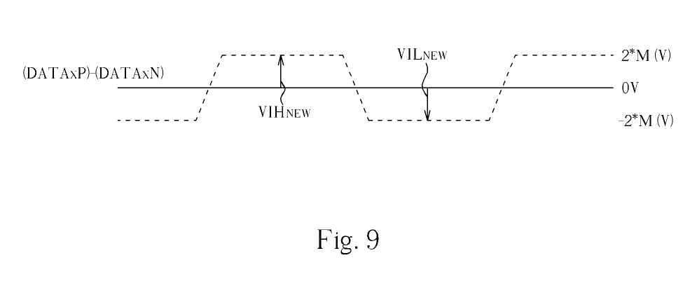

According to the process 60, the embodiment utilizes a differential signal interface having variable currents to realize the current patterns in Step 606 and the data transmission modes. Please refer to FIGS. 7-9, which are schematic diagrams of signals of the differential signal interface according to an embodiment of the present invention. In FIG. 7, similar to FIG. 1, the differential voltage signals DATAxN and DATAxP can be adjusted based on a current to alternatively provide a positive voltage swing VIH_{NEW} and a negative voltage swing VIL_{NEW}. The timing controller adjusts the currents of a differential signaling line pair DATAxN/DATAxP, and the currents thereby induce different voltages across an internal terminal resistor in the source driver. Thus, the amount of variation of the positive and negative voltage swings VIH_{NEW} and VIL_{NEW} is proportional to the amount of current variation of the differential signaling line pair resulting from the timing controller. In FIGS. 8 and 9, the differential voltage signal DIF_{NEW}(DATAxP-DATAxN) has six possible direct-current (DC) voltages, +/−1*M, +/−3*M and +/−4*M, where M represents a unit voltage. Therefore, the present invention utilizes behavior of the differential voltage signal to define the current patterns, and thereby establishes the corresponding relationship between the current patterns and the data transmission modes.

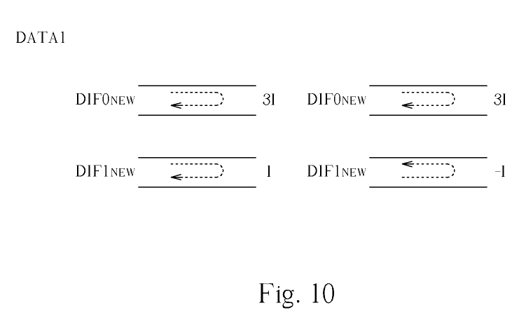

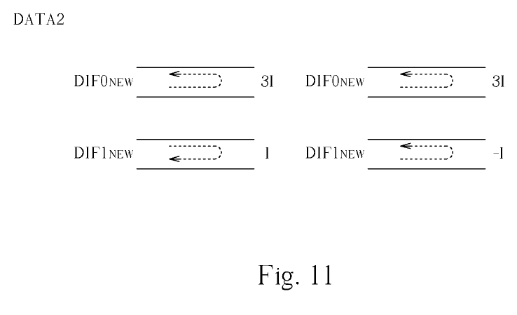

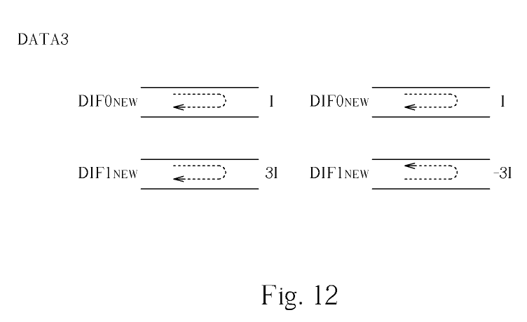

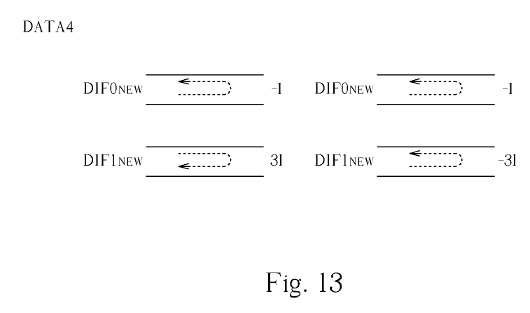

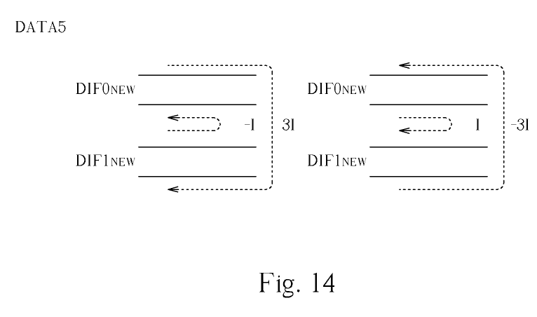

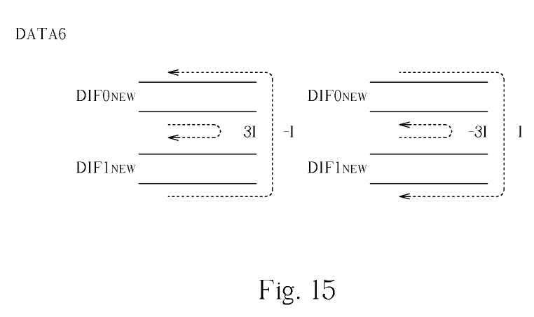

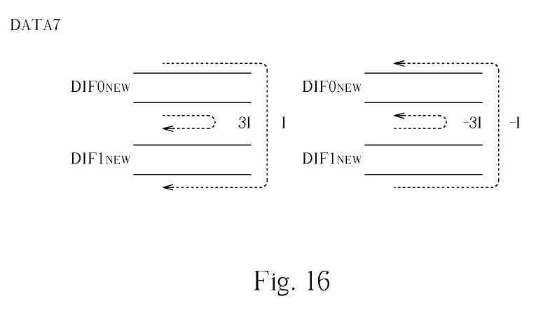

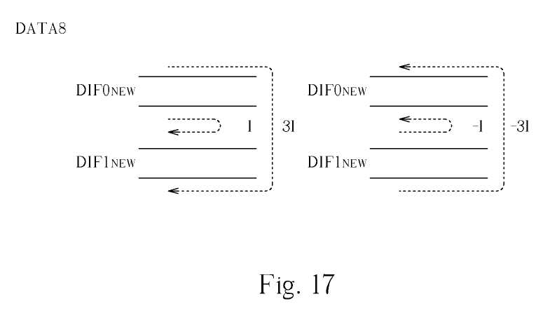

Please refer to FIGS. 10-17, which are schematic diagrams of the current patterns and the data transmission modes according to an embodiment of the present invention. Each of the data transmission modes DATA1-DATA8 shown in FIGS. 10-17 corresponds to a current pattern. In this embodiment, the timing controller employs two differential signaling line pairs DATA0P/N and DATA1P/N to output the current patterns. The source driver can obtain differential voltage signals DIF0_{NEW} and DIF1_{NEW} by sensing and decoding the voltage across internal terminal resistors coupled to the differential signaling line pairs DATA0P/N and DATA1P/N. Taking the data transmission mode DATA1 in FIG. 10 for example, the timing controller generates one differential voltage signal having a DC voltage of +3*M via the differential signaling line pair DATA0P/N, and another having a DC voltage of ±1*M via the differential signaling line pair DATA1 P/N, where + and − represent two opposite directions. That is, the data transmission mode DATA1 corresponds to the current pattern (DIF0_{NEW}: +3*M, DIF1_{NEW}: ±1*M), where the current direction of the differential voltage signal DIF1_{NEW} is used to identify the rising or falling edge of the clock signal. Similarly, the data transmission modes DATA2 through DATA4 correspond to the current patterns (DIF0_{NEW}: −3*M, DIF1_{NEW}: ±1*M), (DIF0_{NEW}: +1*M, DIF1_{NEW}: ±3*M) and (DIF0_{NEW}: −1*M, DIF1_{NEW}: ±3*M), respectively. As for the data transmission mode DATA5 in FIG. 14, the timing controller generates a differential voltage signal having the DC voltage of 3*M via the differential signaling lines DATA0P and DATA1N, and another having the DC voltage of 1*M via the differential signaling lines DATA0N and DATA1P. That is, the data transmission mode DATA5 corresponds to the current pattern (DIF0_{NEW}: +4*M, DIF1_{NEW}: +4*M) or (DIF0_{NEW}: −4*M, DIF1_{NEW}: −4*M), where the current direction of the differential voltage signal DIF1_{NEW} is used to identify the rising or falling edge of the clock signal as well. Similar to the data transmission mode DATA5, the data transmission mode DATA6 corresponds to the current pattern (DIF0_{NEW}: −4*M, DIF1_{NEW}: −4*M) or (DIF0_{NEW}: +4*M, DIF1_{NEW}: +4*M).

FIGS. 10-17 depict different current patterns corresponding to data transmission modes DATA1-DATA8. Those skilled in the art could make modifications to define which signal type every data transmission mode should transmit. For example, the data transmission modes DATA1-DATA6 can be defined as a CONTROL mode, a DIO mode, a DATA mode, an OUTPUT mode, a SYNC mode, and an LD mode, respectively. The SYNC mode is used for transmitting a synchronization signal to reset the source driver and initiate circuits inside the source driver synchronously. The LD mode is used for transmitting a data output synchronization signal to synchronize output timing of image data in the source driver. The CONTROL mode is used for transmitting a control signal to provide various setting signals for the source driver. The DIO mode is used for transmitting a latch signal to instruct the source driver to perform data latching. The DATA mode is used for transmitting a data signal to transmit the image data from the timing controller to the source driver. The OUTPUT mode is used for transmitting a voltage output signal to drive the source driver to output the image data. In such architecture, the control, setting and data signals used in the display device are jointly embedded in two differential signaling line pairs. Therefore, the number of wires in the PCB can be reduced, and the synchronization problem can be solved in high data-rate applications. Furthermore, the data transmission modes DATA1-DATA4 correspond to a first transmission mode group, whereas the data transmission modes DATA5-DATA8 correspond to a second transmission mode group, allowing the source driver to identify the received data transmission mode easily.

Please note that those skilled in the art could increase or decrease the amount of current patterns according to the data transmission modes of different display devices. Further, the operation and operating interval of each data transmission mode can be modified based on the system. For instance, the SYNC mode is not limited to transmitting only the synchronization signal, and can be used for transmitting the synchronization and data output synchronization signals simultaneously. The operating interval is not a specific period of time and set to be an exact multiple of clock cycles.

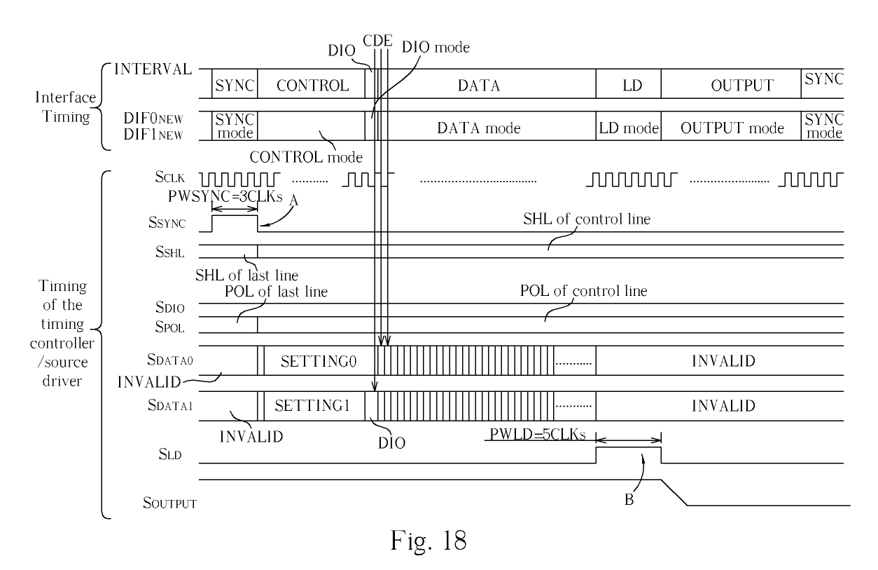

Please refer to FIG. 18, which is a timing diagram of the data transmission modes and corresponding signals of a serial interface according to FIGS. 10-17. In FIG. 18, the timing of the differential voltage signals DIF0_{NEW} and DIF1_{NEW} can be decoded as the SYNC, CONTROL, DIO, DATA, LD or OUTPUT modes. And, operating intervals of all the data transmission modes are multiple times a cycle of a clock signal S_{CLK}. According to signals commonly used in the interface between the timing controller and the source driver, a left/right shift signal S_{SHL} and a polarity signal S_{POL} are transmitted in the CONTROL mode. Data signals S_{DATA0} and S_{DATA1} are transmitted in the DATA mode. A synchronization signal S_{SYNC}, a latch signal S_{DIO}, a data output synchronization signal S_{LD} and a voltage output signal S_{OUTPUT} are correspondingly transmitted in the SYNC, DIO, DATA, LD and OUTPUT modes. Operation of the serial interface is described as follows. When operating in the SYNC mode (the point A), the timing controller outputs a current pattern via the differential signaling line pairs DATA0P/N and DATA1P/N. The voltage across the terminal resistor of the source driver appears as (DIF0_{NEW}: +4*M, DIF1_{NEW}: +4*M) or (DIF0_{NEW}: −4*M, DIF1_{NEW}: −4*M). The source driver thereby starts to receive the synchronization signal S_{SYNC}, to reset and synchronize internal circuits after the voltage signal is decoded. Similarly, in the LD mode (point B), the voltage across the terminal resistor appears as (DIF0_{NEW}: −4*M, DIF1_{NEW}: −4*M) or (DIF0_{NEW}: +4*M, DIF1_{NEW}: +4*M), and thereby the source driver receives the data output synchronization signal S_{LD} to synchronize output timing of the image data. Additionally, the voltage corresponding to the DIO mode (point C) is (DIF0_{NEW}: −3*M, DIF1_{NEW}: ±1*M), and the source driver thereby receives the latch signal S_{DIO} to perform data latch. The voltages corresponding to the DATA mode (points D and E) are (DIF0_{NEW}: +1*M, DIF1_{NEW}: +3*M) and (DIF0_{NEW}: +1*M, DIF1_{NEW}: −3*M), respectively. In the DATA mode, the source driver receives the data signals S_{DATA0} and S_{DATA1} to receive the image data on both the rising and falling edges of the clock signal S_{CLK}.

Please note that the data transmission modes of the display device may be modified according to the requirements of the timing controller or the source driver. For instance, those skilled in the art could select only the SYNC, CONTROL, DIO and DATA modes to use. The SYNC mode is set to transmit both the synchronization signal S_{SYNC} and the data output synchronization signal S_{LD}, whereas the CONTROL, DIO and DATA modes are used for transmitting the control signals, the latch signal S_{DIO}, and the data signal S_{DATA}, respectively. Thus, the required operations of the timing controller and the source driver can be achieved as well.

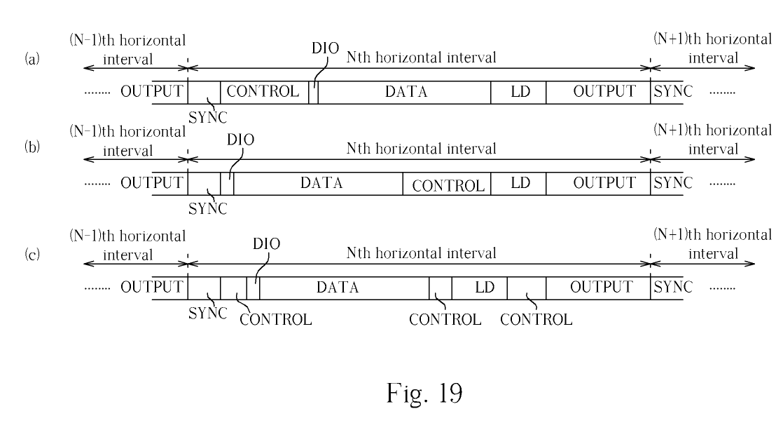

Please refer to FIG. 19, which is a timing diagram of a serial interface according to an embodiment of the present invention. To achieve all functions of the display device, the timing interval of the serial interface includes the above-mentioned data transmission modes, which are arranged based on a predetermined rule. In the embodiment of the present invention, the predetermined rule specifies that the DATA mode should be situated between the SYNC and LD modes. The CONTROL mode can be divided into several segments, as shown in FIG. 19(c), and should be situated between the SYNC and OUTPUT modes. As can been seen in FIG. 19, the control, setting (such as the synchronization and data output synchronization signals), and data signals are embedded jointly into the same serial interface, and the transmission protocol between the timing controller and the source driver is established by the data transmission modes.

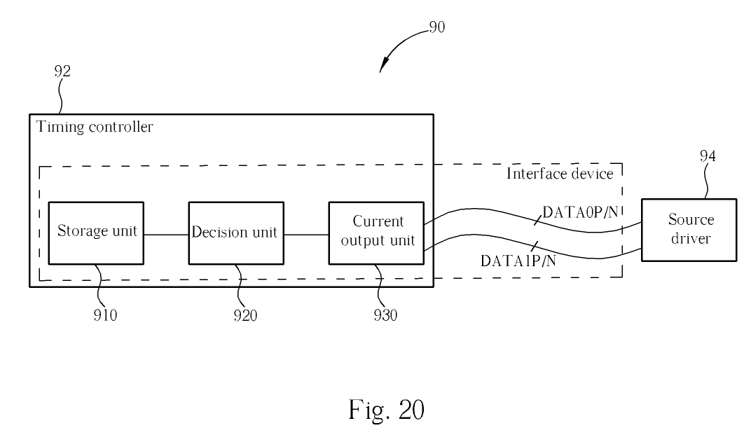

Please refer to FIG. 20, which is a schematic diagram of a serial interface device 900 for use in a timing controller 92 of a display device 90 according to an embodiment of the present invention. The serial interface device 900 includes differential signaling line pairs DATA0P/N and DATA1P/N, a storage unit 910, a decision unit 920 and a current output unit 930. The display device 90 defines different current patterns for multiple existing data transmission modes and stores them in the storage unit 920. As the timing controller 92 operates in one of the data transmission modes, the decision unit 920 selects one current pattern from the storage unit 910 according to the present data transmission mode. The current output unit 930 then outputs the selected current pattern to a source driver 94 via the differential signaling line pairs DATA0P/N and DATA1P/N. The source driver 94 detects voltages across internal terminal resistors and thereby decodes the current pattern to obtain the corresponding data transmission mode. According to the obtained data transmission mode, the source driver 94 can identify received signal types, such as control, data, or setting signals, and perform operations accordingly. The embodiment of the present invention couples the timing controller to each source driver via a dedicated channel. That is, the timing controller employs two differential signaling line pairs to transmit signals for each source driver. Certainly, those skilled in the art could increase or decrease the number of transmission lines (e.g. the number of differential signaling line pairs) depending on the number of data transmission modes of the display device.

In conclusion, regarding the interfacing transmission, the prior art utilizes different current directions to achieve the purpose of data transmission. Each differential signaling line pair can only represent one-bit information, and non-data signals, such as control or setting signals are transmitted via different interfaces. However, the present invention utilizes both current directions and intensities to perform serial transmission. Each differential signaling line pair can transmit information larger than one bit with various current patterns defined corresponding to the transmission modes. Therefore, the non-data signals used in the timing controller can be embedded in the transmission lines and transmitted with data signals jointly. Regarding hardware implementation, the prior art adopts different interface types and bus architecture to perform signal transmission, resulting in a large amount of pins used in the electronic device, which is liable to produce signal reflections. On the contrary, the present invention adopts a serial interface and dedicated channel to transmit the signals jointly, reducing the number and area of wires. Finally, impedance matching between the transmitting and receiving device are easier to realize in the present invention. Therefore, the present invention obviously improves transmission performance compared with the prior art.

Those skilled in the art will readily observe that numerous modifications and alterations of the device and method may be made while retaining the teachings of the invention.

What is claimed is:

1. A serial transmission method for a display device comprising:
obtaining a plurality of data transmission modes of the display device;
defining a plurality of current patterns by a plurality of current intensities and a plurality of current directions according to the plurality of data transmission modes, each current pattern corresponding to one of the plurality of data transmission modes; and
outputting one of the plurality of current patterns to an electronic device of the display device via a plurality of transmission lines according to a present data transmission mode.

2. The serial transmission method of claim 1, wherein the plurality of data transmission modes are transmission modes selected from a SYNC mode, an LD mode, a CONTROL mode, a DIO mode, a DATA mode and an OUTPUT mode, where the SYNC mode is used for transmitting a synchronization signal to reset the electronic device and initiate circuits of the electronic device synchronously or transmitting the synchronization signal and a data output synchronization signal simultaneously; the LD mode is used for transmitting the data output synchronization signal to synchronize output timing of image data; the CONTROL mode is used for transmitting a control signal to provide a plurality of setting signals for the electronic device; the DIO mode is used for transmitting a latch signal to instruct the electronic device to perform data latching; the DATA mode is used for transmitting a data signal to transmit the image data to the electronic device; the OUTPUT mode is used for transmitting a voltage output signal to drive the electronic device to output the image data.

3. The serial transmission method of claim 2, wherein the SYNC mode and the LD mode correspond to a first group, whereas the CONTROL mode, the DIO mode, the DATA mode and the OUTPUT mode correspond to a second group.

4. The serial transmission method of claim 2 further comprising determining an output priority of the plurality of data transmission modes according to a predetermined rule.

5. The serial transmission method of claim 1, wherein the plurality of transmission lines comprises two transmission line pairs, each comprising two transmission lines.

6. The serial transmission method of claim 5, wherein the plurality of current intensities correspond to two current intensities, and the plurality of current directions correspond to a positive current direction and a negative current direction opposite to the positive current direction.

7. The serial transmission method of claim 1, wherein the plurality of transmission lines is a plurality of differential signaling line pairs.

8. A serial interface device for a display device comprising:
a plurality of transmission lines;
a storage unit for storing a plurality of current patterns defined by a plurality of current intensities and a plurality of current directions, each current pattern corresponding to one of a plurality of data transmission modes of the display device;
a decision unit coupled to the storage unit for selecting a current pattern from the plurality of current patterns stored in the storage unit according to a present data transmission mode; and
a current output unit coupled to the decision unit for outputting the current pattern to an electronic device of the display device via the plurality of transmission lines.

9. The serial interface device of claim 8, wherein the plurality of data transmission modes are transmission modes selected from a SYNC mode, an LD mode, a CONTROL mode, a DIO mode, a DATA mode and an OUTPUT mode, where the SYNC mode is used for transmitting a synchronization signal to reset the electronic device and initiate circuits of the electronic device synchronously or transmitting the synchronization signal and a data output synchronization signal simultaneously; the LD mode is used for transmitting the data output synchronization signal to synchronize output timing of image data; the CONTROL mode is used for transmitting a control signal to provide a plurality of setting signals for the electronic device; the DIO mode is used for transmitting a latch signal to instruct the electronic device to perform data latching; the DATA mode is used for transmitting a data signal to transmit the image data to the electronic device; the OUTPUT mode is used for transmitting a voltage output signal to drive the electronic device to output the image data.

10. The serial interface device of claim 9, wherein the SYNC mode and the LD mode correspond to a first group, whereas the CONTROL mode, the DIO mode, the DATA mode and the OUTPUT mode correspond to a second group.

11. The serial interface device of claim 9, wherein the current output unit further comprises a predetermined rule used for determining an output priority of the plurality of data transmission modes.

12. The serial interface device of claim 8, wherein the plurality of transmission lines comprises two transmission line pairs, each comprising two transmission lines.

13. The serial interface device of claim 12, wherein the plurality of current intensities correspond to two current intensities, and the plurality of current directions correspond to a positive current direction and a negative current direction opposite to the positive current direction.

14. The serial interface device of claim 8, wherein the plurality of transmission lines is a plurality of differential signaling line pairs.
